(19) United States
(12) Patent Application Publication
(10) Pub. No.: US 2023/0345983 A1
(43) Pub. Date: Nov. 2, 2023

(54) FLAVOUR COMPOSITIONS FOR IMPROVING TASTE IMPRESSIONS

(71) Applicant: SYMRISE AG, Holzminden (DE)

(72) Inventors: Klaus HERBRAND, Höxter (DE); Jens KOCH, Eschershausen (DE); Frank SCHILD, Holzminden (DE)

(21) Appl. No.: 17/997,835

(22) PCT Filed: May 4, 2020
(86) PCT No.: PCT/EP2020/062285

§ 371 Date: Nov. 3, 2022

(51) Int. Cl. A23L 27/21; A23L 27/22; A23L 27/20; A23J 3/14; A23L 27/00; A23J 3/22

(52) U.S. Cl. CPC A23L 27/215; A23L 27/22; A23L 27/204; A23L 27/2028; A23L 27/2022; A23L 27/2054; A23J 3/14; A23L 27/88; A23L 27/84; A23J 3/227

(57) ABSTRACT

The present invention relates to new flavour compositions, a method for producing such flavour compositions, the use of such flavour compositions for enhancing and/or imparting desired taste impressions and/or for reducing and/or masking undesired taste impressions, as well as to a product or semi-finished product comprising such a flavour composition. Furthermore, the present invention relates to the use of a sugar composition in the preparation of such a flavour composition.

The present invention relates to new flavour compositions, a method for producing such flavour compositions, the use of such flavour compositions for enhancing and/or imparting desired taste impressions and/or for reducing and/or masking undesired taste impressions, as well as to a product or semi-finished product comprising such a flavour composition. Furthermore, the present invention relates to the use of a sugar composition in the preparation of such a flavour composition.

Further aspects of the present invention or in connection therewith as well as preferred embodiments will be described below as well as in the attached claims.

Due to different reasons, an increasing number of people rearranges their type of nutrition to a meat-free or meat-reduced nutrition. Several forms and “lifestyles” have developed, ranging from a general reduction of meat in the daily food to a vegetarian or vegan nutrition.

The underlying reasons broadly vary from ethical aspects over religious or cultural conviction up to general well-being and health reasons as well as environmental aspects. As in a majority of cases, the taste of meat and meat products itself is not the cause for reducing/avoiding meat and is frequently still perceived as a pleasant taste, many people are searching for alternative food products which are meat-free but still provide a meat or meat-like taste.

For some time, the food industry has started to develop and provide meat-free food products for replacing meat in the daily nutrition. Usually, these alternatives are protein-based products, which contain flavour compositions to provide a meat-like taste.

As the original taste of meat is a very complex taste including flavours such as “mouthfeel”, “juicy”, “fatty”, “roasted” or “meaty”, it is very difficult to closely imitate the original taste of meat. Even though several products are already available on the market, which provide an acceptable meat-like taste, and even though the development of improved flavours is ongoing, the difference between meat-containing and meat-free food products can still be perceived by consumers. Even though a high interest and effort exists in optimizing the meat-like taste, such protein-based products still provide several undesired/unpleasant taste impressions such as a pea off-note or a bitter, earthy, beany and/or chalky taste, in some cases evoked by soybean or some of its proteins, and thus reduce the pleasure of meat-free or meat-reduced nutrition.

Therefore, a high need exists for improving the possibilities of imitating the complex taste of meat to enable a meat-free or meat-reduced nutrition without renouncing the original taste of meat.

It was thus the primary object of the present invention to improve the gustatory quality of food products or flavours compositions, which shall provide a meat-like taste. It was thus an object of the present invention to provide novel preparations, which enhance and/or impart a meat-like taste. Furthermore, it was an object of the present invention to provide novel preparations, which reduce the undesired/unpleasant taste impressions such as a pea off-note and/or a bitter, earthy, beany and/or chalky taste, which are currently perceived in food products or flavours compositions, which shall provide a meat-like taste. Further objects underlying the present invention become apparent when studying the following description including examples and the advantageous effects mentioned herein.

The primary object of the present invention is achieved by a flavour composition, preferably in form of a powder, comprising
a) Tyrosine, Phenylalanine, Tryptophan and Glutamic acid,
wherein the weight ratio of Tyrosine and Glutamic acid is in a range of from 0.5 to 1, preferably in a range of from 0.75 to 0.9
wherein the weight ratio of Phenylalanine and Glutamic acid is in a range of from 0.5 to 1, preferably in a range of from 0.6 to 0.8
and
wherein the weight ratio of Tryptophan and Glutamic acid is in a range of from 0.05 to 0.3, preferably in a range of from 0.1 to 0.2.

It is further preferred that the weight ratio of Phenylalanine and Tyrosine is in a range of from 0.25 to 1.5, preferably in a range of from 0.5 to 1.

It is further preferred that the weight ratio of Tryptophan and Tyrosine is in a range of from 0.05 to 0.75, preferably in a range of from 0.1 to 0.5.

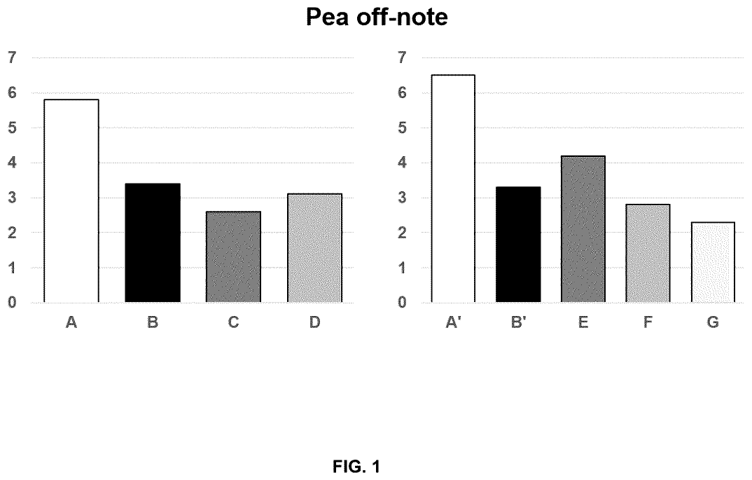

It was surprisingly found that the flavour composition according to the invention is able to strongly reduce the undesired pea off-note in protein-based food products. Furthermore, it was unexpectedly found that the flavour composition according to the invention increases the pleasant flavours “juicy”, “fatty”, “meaty”, “mouthfeel” and “roasted” in such products (see Examples 3.1 to 3.6 and FIGS. 1 to 6).

The terms “Tyrosine”, “Phenylalanine”, “Tryptophan” and “Glutamic acid” include the respective amino acids. Preferably, these terms describe the L-form of the respective amino acid(s), i.e. L-Tyrosine and/or L-Phenylalanine and/or L-Tryptophan and/or L-Glutamic acid.

The amounts of Tyrosine, Phenylalanine and Tryptophan are indicated in relation to the amount of Glutamic acid. Preferably, Glutamic acid is present in the composition in an amount of at least 2000 ppm, preferably at least 4000 ppm, further preferably at least 5000 ppm. Preferably, Glutamic acid is present in the composition in an amount of at least 0.001 wt.-%, preferably at least 0.01 wt.-%, further preferably at least 0.1 wt.-%, even further preferably, at least 1 wt.-%. Preferably, the amount of Glutamic acid in the composition is in the range of up to 60 wt.-%, preferably up to 50 wt.-%, further preferably up to 45 wt.-%, even further preferably up to 42.5 wt.-%. It is further preferred that the amount of Glutamic acid in the composition is in the range of from any preferred minimum range to any preferred maximum range. Thus, preferably, the amount of Glutamic acid in the composition is for example in the range of from 0.001 to 60 wt.-%, preferably from 0.01 to 50 wt.-%, further preferably from 0.1 to 45 wt.-%, particularly preferably from 1 to 42.5 wt.-%.

Preferably, the flavour composition according to the invention further comprises
b) one, two, three or more substance(s) selected from aldehydes, fatty acids, phenols and ketones,
preferably wherein the, one, two, three or more of the substance(s) b) is/are selected from the group consisting of 2,2-transphenylbutenal, caprylic acid, 2-heptanone, 2-methylbutanal, 5,2,2-transmethylphenyl hexenal, caprinic acid, isobutyraldehyde, isovaleraldehyde, phenylacetaldehyde, vinyl guaiacol, 3-methyl thiopropanal and benzaldehyde,
preferably wherein the or one of the substance(s) b) is 2-methylbutanal.

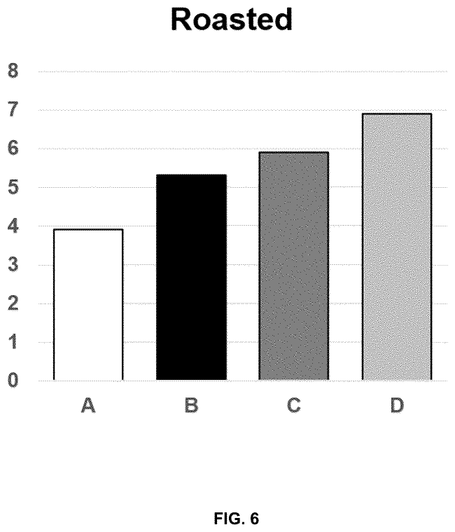

It was surprisingly found that the addition of component b), as described above, further reduced the unpleasant pea off-note and increased the pleasant roasted taste impression (see Examples 3.1 and 3.6 and FIGS. 1 and 6).

It is even further preferred that component b) comprises 2-methylbutanal, as described above, and also
isovaleraldehyde, preferably wherein the weight ratio of isovaleraldehyde and 2-methylbutanal is in a range of from 0.05 to 1, preferably in a range of from 0.1 to 0.75,
and/or
5,2,2-transmethylphenyl hexenal, preferably wherein the weight ratio of 5,2,2-transmethylphenyl hexenal and 2-methylbutanal is in a range of from 0.01 to 0.75, preferably in a range of from 0.075 to 0.3,
and/or
isobutyraldehyde, preferably wherein the weight ratio of isobutyraldehyde and 2-methylbutanal is in a range of from 0.01 to 0.75, preferably in a range of from 0.075 to 0.3.

Additionally or alternatively, it is also preferred that the flavour composition according to the invention further comprises
c) one, two, three or more pyrazine(s),
preferably wherein the, one, two three or more of the pyrazine(s) is selected from the group consisting of 2,3-methylisobutylpyrazine, 2,3-dimethylpyrazine, 2,3,5-dimethylethylpyrazine, 2,3,6-dimethylethylpyrazine, 2,3,5-trimethylpyrazine, 2,5-dimethylpyrazine, 2,5-methylethylpyrazine, 2,6-methylethylpyrazine, 2-methylpyrazine, 2,6-dimethylpyrazine and 2-ethylpyrazine,
preferably wherein the or one of the pyrazine(s) is 2,5-dimethylpyrazine.

Preferably, the pyrazines as described above are represented by the following chemical structures and/or IUPAC names:

| Chemical name as | | |
|---|---|---|
| used herein | Chemical structure | IUPAC name |
| 2,3- methylisobutyl- pyrazine | 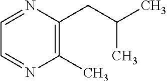 | 2-isobutyl-3-methyl- pyrazine |
| 2,3-dimethyl- pyrazine | 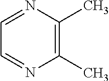 | 2,3-dimethylpyrazine |
| 2,3,5- dimethylethyl- pyrazine | 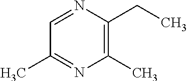 | 2-ethyl-3,5-dimethyl- pyrazine |
| 2,3,6- dimethylethyl- pyrazine | 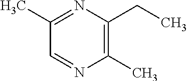 | 3-ethyl-2,5-dimethyl- pyrazine |
| 2,3,5-trimethyl- pyrazine | 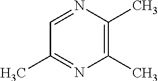 | 2,3,5-trimethyl- pyrazine |
| 2,5-dimethyl- pyrazine | 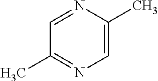 | 2,5-dimethylpyrazine |
| 2,5- methylethyl- pyrazine | 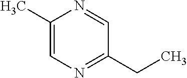 | 2-ethyl-5-methyl- pyrazine |
| 2,6- methylethyl- pyrazine | 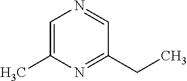 | 2-ethyl-6-methyl- pyrazine |
| 2-methylpyrazine | 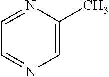 | 2-methylpyrazine |
| 2,6-dimethyl- pyrazine | 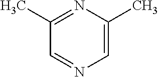 | 2,6-dimethylpyrazine |
| 2-ethylpyrazine | 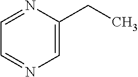 | 2-ethylpyrazine |

Preferably, in the case of discrepancies between the name of a chemical structure and the structure described in connection therewith, the compound described by the depicted chemical structure is meant.

It was surprisingly found that the addition of component c), as described above, further increased the pleasant roasted taste impression (see Example 3.6 and FIG. 6).

It was even more surprising that the addition of both, component b) and c), each as described above, even further reduced the undesired pea off-note and further increased the pleasant taste impressions “mouthfeel”, “juicy” and “meaty” (see Examples 3.1, 3.2, 3.4 and 3.6. and FIGS. 1, 2, 4 and 5).

It is even further preferred that component c) comprises 2,5-dimethylpyrazine, as described above, and also
2,5-methylethylpyrazine and/or 2,6-methylethylpyrazine, preferably wherein the weight ratio of the sum of 2,5-methylethylpyrazine and 2,6-methylethylpyrazine, and 2,5-dimethylpyrazine is in a range of from 0.25 to 1.25, preferably in a range of from 0.5 to 1,
and/or
2,3,5-trimethylpyrazine, preferably wherein the weight ratio of 2,3,5-trimethylpyrazine and 2,5-dimethylpyrazine is in a range of from 0.1 to 1, preferably in a range of from 0.25 to 0.75.

The term “the weight ratio of the sum of 2,5-methylethylpyrazine and 2,6-methylethylpyrazine, and 2,5-dimethylpyrazine” is meant to be understood such that the summed weight of 2,5-methylethylpyrazine and 2,6-methylethylpyrazine, each as far as present, is set in relation to the weight of 2,5-dimethylpyrazine.

As far as not already included in any of the components a), b) or c), it is further preferred that the flavour composition according to the invention further comprises
d) one, two, three or more substance(s) selected from edible acids, sugars, ribonucleotides, nucleosides, mineral substances.

In case one or further substance(s) can be grouped under compounds a), b) or c) and also under compound d), the substance(s) is/are considered as compound a), b) or, respectively, c) for all calculations of weights and weight ratios.

It is further preferred according to the invention that the flavour composition according to the invention is prepared or producible by a method comprising the steps
a) enzymatic degradation of proteins to obtain a mixture comprising amino acids or providing a mixture comprising amino acids,
b) optionally: adding carbohydrates to the mixture
c) heating the mixture obtained or provided in step a) or, respectively, b) to apply a Maillard reaction,
d) optionally: drying the mixture, preferably by spray drying, to obtain a powder.

Preferably in the above method, the proteins, if present, in step a) are vegetable proteins, i.e. proteins of vegetable origin.

Additionally or alternatively, the carbohydrates in step b), if present, are obtained from cereals. Further preferably, the carbohydrates are selected from the group consisting of rhamnose, arabinose, galactose and xylose and any mixtures thereof. Particularly preferably, the carbohydrates used in step b) include rhamnose, arabinose, galactose and xylose.

Further preferably wherein the amount of rhamnose is in a range of from 0.05 to 1.5 wt.-%, preferably of from 0.2 to 0.6 wt.-%, and/or preferably wherein the amount of arabinose is in a range of from 1 to 10 wt.-%, preferably of from 3.6 to 6.4 wt.-%, and/or preferably wherein the amount of galactose is in a range of from 0.1 to 5 wt.-%, preferably of from 0.6 to 1.4 wt.-%, and/or preferably wherein the amount of xylose is in a range of from 0.1 to 5 wt.-%, preferably of from 0.6 to 1 wt.-%, each based on the dry weight of the mixture obtained in step b) (which includes the carbohydrate(s)).

Additionally or alternatively, the mixture obtained or provided in step a) or b) is heated to a temperature in a range of from 130° C. to 140° C.

The present invention further relates to a method for producing a flavour composition according to the invention, comprising the steps
a) enzymatic degradation of vegetable proteins to obtain a mixture comprising amino acids or providing a mixture comprising amino acids,
b) optionally: adding carbohydrates to the mixture, preferably wherein the carbohydrates are obtained from cereals and comprise rhamnose, arabinose, galactose and/or xylose, preferably a mixture of rhamnose, arabinose, galactose and xylose,
c) heating the mixture obtained or provided in step a) or b), preferably to a temperature in a range of from 130° C. to 140° C., to apply a Maillard reaction,
d) optionally: drying the mixture, preferably by spray drying, vacuum oven drying, vacuum belt drying, roll dryer and vacuum roll dryer and/or extrusion, to obtain a powder
or
to a method for producing a flavour composition, preferably a flavour composition according to the invention, comprising the steps
a) enzymatic degradation of vegetable proteins to obtain a mixture comprising amino acids,
b) adding carbohydrates to the mixture, wherein the carbohydrates are obtained from cereals and comprise rhamnose, arabinose, galactose and/or xylose, preferably a mixture of rhamnose, arabinose, galactose and xylose,
c) heating the mixture obtained in step a) or b) to a temperature in a range of from 130° C. to 140° C., to apply a Maillard reaction,
d) drying the mixture, preferably by spray drying, vacuum oven drying, vacuum belt drying, roll dryer and vacuum roll dryer and/or extrusion, to obtain a powder.

Further preferably wherein the amount of rhamnose is in a range of from 0.05 to 1.5 wt.-%, preferably of from 0.2 to 0.6 wt.-%, and/or preferably wherein the amount of arabinose is in a range of from 1 to 10 wt.-%, preferably of from 3.6 to 6.4 wt.-%, and/or preferably wherein the amount of galactose is in a range of from 0.1 to 5 wt.-%, preferably of from 0.6 to 1.4 wt.-%, and/or preferably wherein the amount of xylose is in a range of from 0.1 to 5 wt.-%, preferably of from 0.6 to 1 wt.-%, each based on the dry weight of the mixture obtained in step b) (which includes the carbohydrate(s)).

The present invention further relates to the use of a composition according to the invention to impart and/or enhance a desired taste impression, preferably of the type(s) mouthfeel, juicy, fatty, roasted and/or meaty, in a preparation for nourishment or pleasure, or in a semi-finished product for the production of a preparation for nourishment or pleasure, preferably wherein the preparation is a protein-based or protein-enriched preparation. Preferably, a protein-based or protein-enriched preparation comprises at least 30 wt.-%, preferably at least 40 wt.-%, preferably at least 50 wt.-%, preferably at least 60 wt.-%, preferably at least 70 wt.-%, preferably at least 80 wt.-%, preferably at least 90 wt.-% proteins, based on the total weight of the preparation.

The present invention is further related to the use of a composition according to the invention to reduce and/or mask an undesired sensory taste impression, preferably bitter, earthy, beany and/or chalky and/or a pea off-note, in a preparation for nourishment or pleasure, or in a semi-finished product for the production of a preparation for nourishment or pleasure, preferably wherein the preparation is a protein-based or protein-enriched preparation.

The term “pea off-note” is well known to a skilled person and frequently used in the field of flavourings. Preferably, it may also be described as “earthy”, “beany” or “chalky”. The same taste impressions (“earthy”, “beany” or “chalky”) are also frequently evoked by soybean products or by one or more proteins of soybeans.

Preferably, the protein-based or protein-enriched preparation as described herein is selected from the group consisting of vegan or vegetarian products that imitate meat products such as fresh meat like steak, chicken breast, cutlet, etc.; minced meat like mince meat from beef, pork, poultry; structured mince meat like burger patties, chevapcici etc.; coated meat products like nuggets, wiener cutlet, cordon blue etc.; meat pieces/stripes, like beef or chicken stripes, kebab; sausages cooked like hot dogs and raw like course sausages; fermented meat like salami; pates like liverpate, teewurst etc.; cooked and raw ham; bacon; as well as the respective meat products themselves.

It has been found that the improvement of the taste, i.e. by imparting and/or enhancing the pleasant taste impressions as described herein and/or by reducing and/or masking the unpleasant taste impressions as described herein, can be achieved in products that imitate meat products as described herein but also in the respective (non-vegan and non-vegetarian) meat products themselves.

Additionally or alternatively, the semi-finished product as described herein for the production of a preparation for nourishment or pleasure is preferably selected from the group consisting of semi-finished product seasonings i.e. type cevapcici, type kebab, type minced, type pulled, type burger; vegan products that imitate eggs (liquid, cooked, scrambled), cheese (hard cheese, soft cheese, fresh cheese), dairy products like milk and yoghurt, ice-cream or fish (raw, cooked); products that are made from plant protein like falafel or humus; meat products like mechanically separated meat mechanically recovered/reclaimed meat or mechanically deboned meat.

Furthermore, the present invention also relates to such a preparation for nourishment or pleasure, or semi-finished product for the production of a preparation for nourishment or pleasure, wherein the preparation or semi-finished product comprises a flavour composition according to the invention, preferably wherein the total amount of the flavour composition is sufficient to impart and/or enhance a desired taste impression, preferably of the type(s) mouthfeel, juicy, fatty, roasted and/or meaty, and/or to reduce and/or mask an undesired sensory taste impression, such as bitter, earthy, beany and/or chalky and/or a pea off-note, preferably wherein the amount of the flavour composition in the preparation or semi-finished product is in a range of from 0.001 to 70 wt.-%, preferably in a range of from 0.005 to 50 wt.-%, further preferably in a range of from 0.01 to 10 wt.-%.

In case of a semi-finished product, it is preferred that the amount of the flavour composition in the semi-finished product is in a range of from 1 to 70 wt.-%, preferably in a range of from 5 to 50 wt.-%, further preferably in a range of from 10 to 40 wt.-%.

In case of a preparation, it is preferred that the amount of the flavour composition in the preparation is in a range of from 0.001 to 10 wt.-%, preferably in a range of from 0.005 to 5 wt.-%, further preferably in a range of from 0.01 to 1 wt.-%.

It is further preferred that the preparation is a protein-based or protein-enriched preparation as described above.

The present invention further relates to the use of a sugar composition comprising or consisting of a mixture of rhamnose, arabinose, galactose and xylose, in a method for producing a flavour composition, preferably a flavour composition according to the invention
wherein the weight ratio of rhamnose and arabinose in the mixture is in a range of from 0.01 to 0.2
and/or wherein the weight ratio of galactose and arabinose in the mixture is in a range of from 0.005 to 0.5
and/or wherein the weight ratio of xylose and arabinose in the mixture is in a range of from 0.005 to 0.5,
preferably wherein in the method, a reaction mixture is provided or produced and heated and wherein preferably the amount of rhamnose is in a range of from 0.05 to 1.5 wt.-%, preferably of from 0.2 to 0.6 wt.-%,
and/or preferably wherein the amount of arabinose is in a range of from 1 to 10 wt.-%, preferably of from 3.6 to 6.4 wt.-%,
and/or preferably wherein the amount of galactose is in a range of from 0.1 to 5 wt.-%, preferably of from 0.6 to 1.4 wt.-%,
and/or preferably wherein the amount of xylose is in a range of from 0.1 to 5 wt.-%, preferably of from 0.6 to 1 wt.-%,
each based on the dry weight of the provided or produced reaction mixture before heating.

A further aspect of the present invention relates to a method for imparting and/or enhancing a desired taste impression, preferably of the type(s) mouthfeel, juicy, fatty, roasted and/or meaty, in a preparation for nourishment or pleasure, or in a semi-finished product for the production of a preparation for nourishment or pleasure, comprising the following steps
a) providing a composition according to the invention,
b) providing components for the production of the preparation or, respectively, the semi-finished product,
c) mixing the composition of step a) and the components of step b) for producing the preparation or, respectively, the semi-finished product, preferably wherein the preparation is a protein-based or protein-enriched preparation.

The mixing step c) of the above method is not restricted to, but may be, a single mixing step of all components of step b) and the composition of step a). The mixing step c) may include mixing some of the components of step b) and the composition of step a), wherein the or some of the further components of step b) can be mixed before and/or afterwards with each other and/or with the composition of step a).

A further aspect of the present invention relates to a method for reducing and/or masking an undesired sensory taste impression, preferably bitter, earthy, beany and/or chalky and/or a pea off-note, in a preparation for nourishment or pleasure, or in a semi-finished product for the production of a preparation for nourishment or pleasure, comprising the following steps
a) providing a composition according to the invention,
b) providing components for the production of the preparation or, respectively, the semi-finished product,
c) mixing the composition of step a) and the components of step b) for producing the preparation or, respectively, the semi-finished product,
preferably wherein the preparation is a protein-based or protein-enriched preparation.

The mixing step c) of the above method is not restricted to, but may be, a single mixing step of all components of step b) and the composition of step a). The mixing step c) may include mixing some of the components of step b) and the composition of step a), wherein the or some of the further components of step b) can be mixed before and/or afterwards with each other and/or with the composition of step a).

FIGS. 1 to 6 show the evaluation of the sensory profile of a vegan burger patty according to Example 1 with flavour compositions according to the invention (B to G; with B and B′: Burger patty of Example 1+Flavour composition of Example 2.1 (as 0.05 wt.-% of the final burger patty); C: Burger patty of Example 1+Flavour composition of Example 2.1 (as 0.05 wt.-% of the final burger patty)+Flavour composition of Example 2.3 (as 0.006 wt.-% of the final burger patty); D: Burger patty of Example 1+Flavour composition of Example 2.1 (as 0.05 wt.-% of the final burger patty)+Flavour composition of Example 2.4 (as 0.05 wt.-% of the final burger patty); E: Burger patty of Example 1+Flavour composition of Example 2.2 (as 0.1 wt.-% of the final burger patty); F: Burger patty of Example 1+Flavour composition of Example 2.1 (as 0.05 wt.-% of the final burger patty)+Flavour composition of Example 2.3 (as 0.006 wt.-% of the final burger patty)+Flavour composition of Example 2.4 (as 0.05 wt.-% of the final burger patty); and G: Burger patty of Example 1+Flavour composition of Example 2.2 (as 0.1 wt.-% of the final burger patty)+Flavour composition of Example 2.3 (as 0.006 wt.-% of the final burger patty)+Flavour composition of Example 2.4 (as 0.05 wt.-% of the final burger patty)) and without such flavour composition (A and A′).

The present invention, preferred embodiments thereof and several aspects in connection therewith will be described below in the form of selected examples.

### EXAMPLES

### Example 1: Test System—Vegan Burger Patty

As a test system for the flavour compositions according to the invention, a vegan burger patty with the following ingredients was prepared:

| | Amount |
|---|---|
| Ingredients | [wt .-%] |
| Sanacel Bamboo add FB | 0.7 |
| Caramel Powder EBC 16000 | 0.6 |
| Exberry powder GNT no. | 0.5 |
| 843310 | |
| Pea Protein Nutralys s85f | 5 |
| Tylopur MCE 100TS | 1.8 |
| (Metelose) | |
| Potato starch | 0.8 |
| Citric acid | 0.02 |
| Salt | 0.9 |
| Dextrose (from Maize) | 1.56 |
| Lactic acid 60% | 0.2 |
| Succinic acid | 0.02 |
| Pepper black powder | 0.05 |
| Yeast extract Maxarome plus | 0.35 |
| Sunflower oil | 9.5 |
| Water | 59 |
| Nutralys T65M/Herba TEX | 14.5 |
| P55 | |
| Coconut oil refined | 4.5 |
| Sum | 100 |

The above vegan burger patty was produced by the following steps:
1. Mix all dry Ingredients,
2. Put pieces ca. 3 cm of Coconut oil refined in Mixer, mix at highest speed 8 to 10 seconds,
3. Store this crumbles in fridge,
4. Put now the dry ingredients in Mixer, blend shortly,
5. Add vegetable oil sunflower, mix (medium speed for 1 min),
6. Add ice water <2° C., mix at highest speed for ca. 1-2 minutes),
7. Cool down the mass for 2 h in fridge,
8. Add pea protein, mix for 2-4 min,
9. Add coconut oil (crumbles), mix shortly,
10. Set under Vacuum,
11. Cool for 24 h,
12. Form patties,
13. Cool or freeze,
14. Fry only defrosted patties to core temperature of 72° C.

### Example 2: Flavour Compositions

The following flavour compositions were prepared:

### Example 2.1: Amino Acid Composition

| | Amount |
|---|---|
| Ingredients | [wt .-%] |
| L-Tyrosine | 30.5 |
| L-Phenylalanine | 25.4 |
| L-Glutamic acid | 38.2 |
| L-Tryptophan | 5.9 |
| Sum | 100 |

### Example 2.2: Amino Acid Composition

| | Amount |
|---|---|
| Ingredients | [wt .-%] |
| L-Ornithine | 0.2 |
| L-Proline | 2.1 |
| L-Aspartic acid | 5.3 |
| L-Threonine | 4.2 |
| L-Alanine | 6.9 |
| L-Glutamine | 3.4 |
| L-Tyrosine | 7.2 |
| L-Isoleucine | 5.8 |
| L-Phenylalanine | 6.0 |
| L-Serine | 5.7 |
| L-Histidine | 2.4 |
| L-Arginine | 16.7 |
| Glutamic acid | 9.0 |
| Glycine | 2.4 |
| L-Leucine | 8.7 |
| L-Valine | 7.9 |
| L-Lysine | 3.2 |
| L-Methionine | 1.5 |
| L-Tryptophan | 1.4 |
| Sum | 100 |

### Example 2.3: Aldehydes, Fatty Acids, Phenols and Ketones

| | Amount |
|---|---|
| Ingredients | [wt .-%] |
| 2,2-transphenylbutenal | 0.10 |
| Caprylic acid | 0.18 |
| 2-heptanone | 0.16 |
| 2-methylbutanal | 4.50 |
| 5,2,2-transmethylphenyl | 0.80 |
| hexenal | |
| Caprinic acid | 0.15 |
| isobutyraldehyde | 0.70 |
| isovaleraldehyde | 1.80 |
| phenylacetaldehyde | 0.76 |
| vinyl guaiacol | 0.60 |
| 3-methyl thiopropanal | 0.12 |
| benzaldehyde | 0.18 |
| Vegetable oil triglyceride palm | 90.25 |
| free | |
| Sum | 100 |

### Example 2.4: Pyrazines

| | Amount |
|---|---|
| Ingredients | [wt .-%] |
| 2,3-methylisobutylpyrazine | 0.025 |
| 2,3-dimethylpyrazine | 0.015 |
| 2,3,5-dimethylethylpyrazine | 0.030 |
| and 2,3,6- | |
| dimethylethylpyrazine | |
| 2,3,5-trimethylpyrazine | 0.100 |
| 2,5-dimethylpyrazine | 0.170 |
| 2,5-methylethylpyrazine and | 0.130 |
| 2,6-methylethylpyrazine | |
| 2-methylpyrazine | 0.020 |
| 2,6-dimethylpyrazine | 0.030 |
| 2-ethylpyrazine | 0.020 |
| Vegetable oil triglyceride palm | 99.46 |
| free | |
| Sum | 100 |

### Example 3: Sensory Profiles

The ingredients of the vegan burger patty of Example 1 were provided and mixed as described above. Subsequently, the following flavour compositions were added and the mixture was processed to the final vegan burger patty:
A: Burger patty of Example 1
B: Burger patty of Example 1+Flavour composition of Example 2.1 (as 0.05 wt.-% of the final burger patty)
C: Burger patty of Example 1+Flavour composition of Example 2.1 (as 0.05 wt.-% of the final burger patty)+Flavour composition of Example 2.3 (as 0.006 wt.-% of the final burger patty)
D: Burger patty of Example 1+Flavour composition of Example 2.1 (as 0.05 wt.-% of the final burger patty)+Flavour composition of Example 2.4 (as 0.05 wt.-% of the final burger patty)
E: Burger patty of Example 1+Flavour composition of Example 2.2 (as 0.1 wt.-% of the final burger patty)
F: Burger patty of Example 1+Flavour composition of Example 2.1 (as 0.05 wt.-% of the final burger patty)+Flavour composition of Example 2.3 (as 0.006 wt.-% of the final burger patty)+Flavour composition of Example 2.4 (as 0.05 wt.-% of the final burger patty)
G: Burger patty of Example 1+Flavour composition of Example 2.2 (as 0.1 wt.-% of the final burger patty)+Flavour composition of Example 2.3 (as 0.006 wt.-% of the final burger patty)+Flavour composition of Example 2.4 (as 0.05 wt.-% of the final burger patty)

The sensory profile of the burger patties A to G was evaluated with a sample size of n=6 for each burger patty. As the evaluation for burger patties E, F and G was performed in a separated approach (but also with burger patties A and B, which are denoted as A′ and B′, as a comparison), the results are shown in separated form and the evaluations of the references A and B slightly differs from A′ and B′.

### Example 3.1: Pea Off-Note

See also FIG. 1.

| | |
|---|---|
| Burger patty | Sensory evaluation |

Reference

| | |
|---|---|
| A | 5.8 |

Amino acids

| | |
|---|---|
| B | 3.4 |

Amino acids + aldehydes, fatty acids, phenols and ketones

| | |
|---|---|
| C | 2.6 |

Amino acids + pyrazines

| | |
|---|---|
| D | 3.1 |

Reference

| | |
|---|---|
| A' | 6.5 |

Amino acids

| B' | 3.3 |
|---|---|
| E | 4.2 |
| Amino acids + aldehydes, fatty acids, phenols | |
| and ketones + pyrazines | |
| F | 2.8 |
| G | 2.3 |

### Example 3.2: Juicy

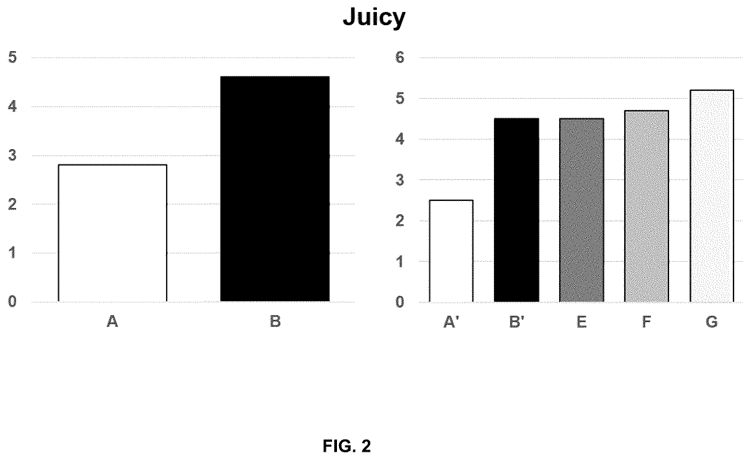

See also FIG. 2.

| | |
|---|---|
| Burger patty | Sensory evaluation |

Reference

| | |
|---|---|
| A | 2.8 |

Amino acids

| | |
|---|---|
| B | 4.6 |

Reference

| | |
|---|---|
| A' | 2.5 |

Amino acids

| B' | 4.5 |
|---|---|
| E | 4.5 |
| Amino acids + aldehydes, fatty acids, phenols | |
| and ketones + pyrazines | |
| F | 4.7 |
| G | 5.2 |

### Example 3.3: Fatty

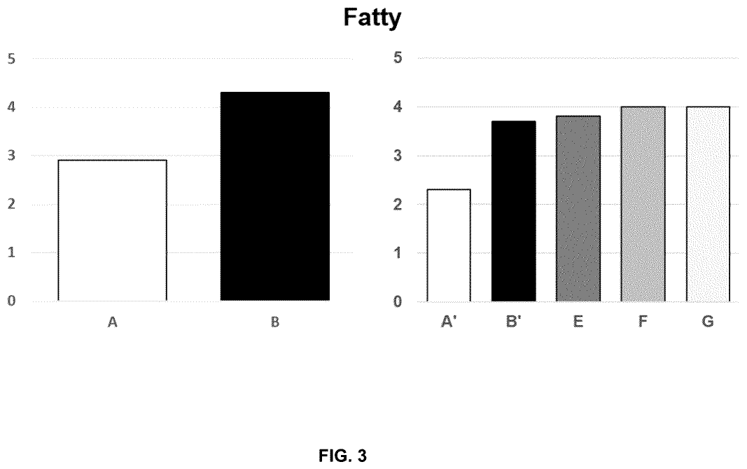

See also FIG. 3.

| | |
|---|---|
| Burger patty | Sensory evaluation |

Reference

| | |
|---|---|
| A | 2.9 |

Amino acids

| | |
|---|---|
| B | 4.3 |

Reference

| | |
|---|---|
| A' | 2.3 |

Amino acids

| B' | 3.7 |
|---|---|
| E | 3.8 |
| Amino acids + aldehydes, fatty acids, phenols | |
| and ketones + pyrazines | |
| F | 4.0 |
| G | 4.0 |

### Example 3.4: Meaty

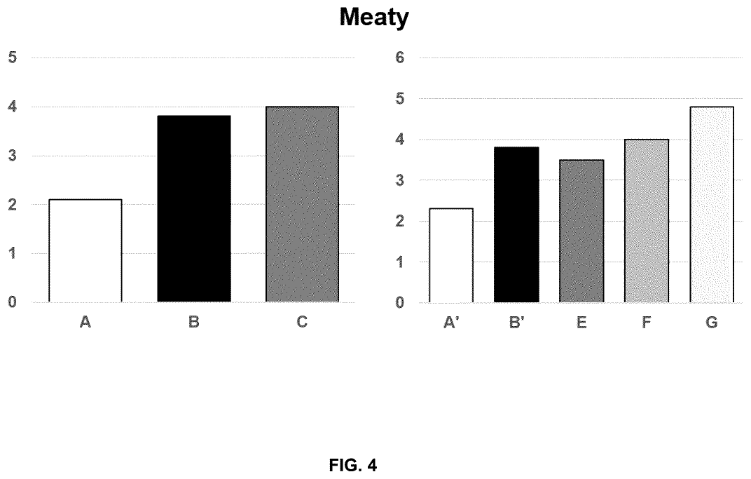

See also FIG. 4.

| | |
|---|---|
| Burger patty | Sensory evaluation |

Reference

| | |
|---|---|
| A | 2.1 |

Amino acids

| | |
|---|---|
| B | 3.8 |

Amino acids + aldehydes, fatty acids, phenols and ketones

| | |
|---|---|
| C | 4.0 |

Reference

| | |
|---|---|
| A' | 2.3 |

Amino acids

| B' | 3.8 |
|---|---|
| E | 3.5 |
| Amino acids + aldehydes, fatty acids, phenols | |
| and ketones + pyrazines | |
| F | 4.0 |
| G | 4.8 |

### Example 3.5: Mouthfeel

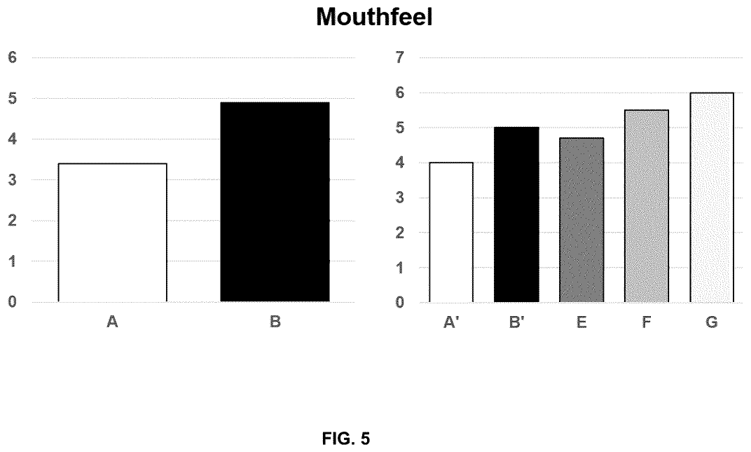

See also FIG. 5.

| | |
|---|---|
| Burger patty | Sensory evaluation |

Reference

| | |
|---|---|
| A | 3.4 |

Amino acids

| | |
|---|---|
| B | 4.9 |

Reference

| | |
|---|---|
| A' | 4.0 |

Amino acids

| B' | 5.0 |
|---|---|
| E | 4.7 |
| Amino acids + aldehydes, fatty acids, phenols | |
| and ketones + pyrazines | |
| F | 5.5 |
| G | 6.0 |

### Example 3.6: Roasted

See also FIG. 6.

| | |
|---|---|
| Burger patty | Sensory evaluation |

Reference

| | |
|---|---|
| A | 3.9 |

Amino acids

| | |
|---|---|
| B | 5.3 |

Amino acids + aldehydes, fatty acids, phenols and ketones

| | |
|---|---|
| C | 5.9 |

Amino acids + pyrazines

| | |
|---|---|
| D | 6.9 |

1. A flavour composition comprising:
(a) Tyrosine, Phenylalanine, Tryptophan, and Glutamic acid,
wherein the Tyrosine and the Glutamic acid are in a weight ratio of 0.5 to 1,
the Phenylalanine and the Glutamic acid are in a weight ratio of 0.5 to 1, and
the Tryptophan and the Glutamic acid is are in a weight ratio of 0.05 to 0.3.

2. The flavour composition of claim 1, further comprising:
(b) one or more compounds selected from aldehydes, fatty acids, phenols, and ketones.

3. The flavour composition of claim 2, wherein the one or more compounds of (b) comprise
2-methylbutanal and isovaleraldehyde,
2-methylbutanal and 5,2,2-transmethylphenyl hexenal, and/or
2-methylbutanal and isobutyraldehyde.

4. The flavour composition of claim 1, further comprising:
(c) one or more pyrazines.

5. The flavour composition of claim 4, wherein the one or more pyrazines of (c) are selected from:
2,5-dimethylpyrazine and one or both of 2,5-methylethylpyrazine and 2,6-methylethylpyrazine, and
2,5-dimethylpyrazine and 2,3,5-trimethylpyrazine.

6. The flavour composition of claim 1, further comprising: d) one, two, three or more substance(s)
(d) one or more substances selected from edible acids, sugars, ribonucleotides, nucleosides, and minerals.

7. The flavour composition of claim 1, producible by a method comprising:
(a) enzymatic degradation of proteins to obtain a mixture comprising amino acids or providing a mixture comprising amino acids;
(b) optionally, adding carbohydrates to the mixture;
(c) heating the mixture obtained of (a) or (b) to apply a Maillard reaction; and
(d) optionally, drying the mixture.

8. The flavour composition of claim 7, wherein the proteins are vegetable proteins, the carbohydrates are obtained from cereals, and the mixture of (a) or (b) is heated to a temperature of 130° C. to 140° C.

9. A method for producing a flavour composition of claim 1 comprising:
(a) enzymatic degradation of vegetable proteins to obtain a mixture comprising amino acids or providing a mixture comprising amino acids;
(b) optionally, adding carbohydrates to the mixture;
c) heating the mixture of (a) or (b) to apply a Maillard reaction; and
d) optionally, drying the mixture.

10. A method for improving a desired taste impression of a preparation comprising adding the flavour composition of claim 1 to the preparation and improving the desired taste impression of the preparation.

11. A method for reducing or masking an undesired taste impression of a preparation comprising adding the flavour composition of claim 1 to the preparation and reducing or masking the undesired taste impression.

12. A preparation comprising 0.001 to 70 wt.-% of the flavor composition of claim 1, relative to a total weight of the preparation. in the preparation or semi-finished product is in a range of from 0.001 to 70 wt.-%, preferably in a range of from 0.005 to 50 wt.-%, further preferably in a range of from 0.01 to 10 wt.-%.

13. The preparation of claim 12 being a protein-based or protein-enriched preparation.

14. The method of claim 9 comprising:
(a) enzymatic degradation of vegetable proteins to obtain a mixture comprising amino acids;
(b) adding carbohydrates to the mixture, wherein the carbohydrates are obtained from cereals and comprise rhamnose, arabinose, galactose and/or xylose;
(c) heating the mixture obtained of (a) or (b) to a temperature of 130° C. to 140° C. to apply a Maillard reaction; and
(d) drying the mixture.

15. The method of claim 14, wherein the carbohydrates of (b) are added in an amount such that:
rhamnose is in a range of from 0.05 to 1.5 wt.-%,
arabinose is in a range of from 1 to 10 wt.-%,
galactose is in a range of from 0.1 to 5 wt.-%, and/or
xylose is in a range of from 0.1 to 5 wt.-%,
relative to a dry weight of the mixture before the heating of (c).

16. The flavor composition of claim 1, further comprising:
(b) one or more compounds selected from 2,2-transphenylbutenal, caprylic acid, 2-heptanone, 2-methylbutanal, 5,2,2-transmethylphenyl hexenal, caprinic acid, isobutyraldehyde, isovaleraldehyde, phenylacetaldehyde, vinyl guaiacol, 3-methyl thiopropanal and benzaldehyde.

17. The flavor composition of claim 1, further comprising:
(b) 2-methylbutanal.

18. The flavor composition of claim 4, wherein the one or more pyrazines are selected from 2,3-methylisobutylpyrazine, 2,3-dimethylpyrazine, 2,3,5-dimethylethylpyrazine, 2,3,6-dimethylethylpyrazine, 2,3,5-trimethylpyrazine, 2,5-dimethylpyrazine, 2,5-methylethylpyrazine, 2,6-methylethylpyrazine, 2-methylpyrazine, 2,6-dimethylpyrazine and 2-ethylpyrazine.

19. The flavour composition of claim 18 comprising 2,5-dimethylpyrazine.

20. The flavour composition of claim 1 in the form of a powder.
